(19) United States
(12) Patent Application Publication
(10) Pub. No.: US 2009/0109163 A1
(43) Pub. Date: Apr. 30, 2009

(54) Driving apparatus, backlight module, and driving method

(75) Inventor: Wei-Ting Yen, Taipei City (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 12/003,187

(22) Filed: Dec. 20, 2007

(30) Foreign Application Priority Data
Oct. 26, 2007 (TW) 096140169

(51) Int. Cl. G09G 3/36

(52) U.S. Cl. 345/102

(57) ABSTRACT

The invention discloses a driving apparatus for driving a back light module, and the driving apparatus comprises a driving unit and a deviation detecting unit. The driving unit is used for driving a plurality of lighting units to emit light. The deviation detecting unit is used for calculating for a current deviation of each of the lighting emitting units. Wherein, when the deviation overtakes a first threshold, the deviation detecting unit controls the driving unit to stop driving the lighting emitting units to light.

### BACKGROUND OF THE INVENTION

1. Field of the Invention

The present invention relates to a driving apparatus and method, and more particularly, to a driving apparatus and method for driving a backlight module of a LCD.

2. Description of the Prior Art

Nowadays, along with the advance of Internet and wireless communication techniques, various kinds of portable computer products, such as a notebook, a mobile phone, a Personal Digital Assistant (PDA), etc., have been rapidly developed and launched. However, because of large volume, heavy weight, and high requirement of power, Cathode Ray Tube (CRT) display is not suitable for those portable computer products. Therefore, LCDs, with the advantages of thin thickness, light weight, and lower power consumption, become the main stream of displays corresponding to the trend of the development of the portable computer products.

At present, the LCD widely used on business situations is Thin-Film LCD (TFT-LCD). The panel itself is not able to light but it can present various gray scales according the light emitted from the backlight module through crystal molecules. The light source of the backlight module includes Cold Cathode Fluorescent Lamp (CCFL), Hot Cathode Fluorescent Lamp (HCLP), Light Emitting Diode (LED), and Electro-Luminscence (EL), wherein CCFL with the advantages of having high luminance, high efficiency, long lifetime, and various appearances, becomes a mainstream light source of the present backlight modules.

Since the backlight area of large-size LCDs is large, the number of the required CCFLs is then increased. Therefore, keeping the brightness difference of the CCFLs in an acceptable range is a critical issue of the backlight module. The brightness of a CCFL is determined according to the current flowing through the CCFL. Therefore, the driving apparatus has a current balancing mechanism, enabling the currents flowing through each of the CCFLs to be substantially similar, for keeping uniform brightness. However, because each of the CCFLs has parasitic capacitances and parametric variations, the current balancing mechanism can not ensure all currents flowing through the CCFLs are totally similar, so that the differences of brightness still exist. When the difference of brightness is overly large, the brightness of the frame of the panel is not uniform and the presenting image is changed, and furthermore, it may cause the user uncomfortable and even damage their vision.

### SUMMARY OF THE INVENTION

Therefore, a scope of the invention is to provide a driving apparatus for driving a backlight module of a LCD. Particularly, the driving apparatus of the invention can control the on/off status of the backlight module according to a current difference to improve the shortcomings of the prior art.

According to an embodiment, the invention discloses a driving apparatus for driving a backlight module of a LCD. The driving apparatus comprises a driving unit and a deviation detecting unit. The driving apparatus is used for driving a plurality of light emitting units of the backlight module lighting. The deviation detecting unit is used for calculating a current deviation of each of the light emitting units. When the calculated current deviation overtakes a first threshold, the deviation detecting unit controls the driving unit to stop driving the light emitting units lighting.

According to another embodiment, the deviation detecting unit of the invention further includes a subtracter, a comparator, and a sender. The operation of the deviation detecting unit includes the following steps: firstly, the subtracter measuring a current difference between each of the light emitting units respectively; afterwards, the comparator calculating the current deviation of each of the light emitting units respectively according to the current difference and the current of each light emitting units; and finally, the sender sending a first controlling signal to control the driving unit to stop driving the light emitting units lighting when the current deviation overtaking the first threshold.

According to another embodiment, the driving apparatus further includes a protecting unit. The protecting unit sends a second controlling signal to control the driving unit to stop driving the light emitting units lighting when the voltage of any of the light emitting units in open circuit overtakes a second threshold. Furthermore, the sender sends a first controlling signal to the protecting unit when the current deviation overtakes the first threshold, so that the protecting unit further sends the second controlling signal to control the driving unit to stop driving the light emitting units lighting.

Another scope of the invention is to provide a backlight module regarded as a light source of a LCD.

According to an embodiment, the backlight module of the invention includes a plurality of light emitting units and a driving apparatus. The apparatus is used for driving the light emitting units lighting. Furthermore, the driving apparatus can calculate a current deviation of each of the light emitting units respectively. When the current deviation overtakes a first threshold, the driving apparatus will stop driving the light emitting units lighting. Besides, the driving apparatus of the backlight module of the invention further includes a driving unit and a deviation detecting unit. The driving unit is used for driving the plurality of light emitting units lighting, and the deviation detecting unit is used for calculating the current deviation of each of the light emitting units.

Another scope of the invention is to provide a driving method for driving a backlight module of a LCD.

According to an embodiment, the driving method of the invention includes the following steps: firstly, driving a plurality of light emitting units of the backlight module lighting; afterwards, calculating a current deviation of each of the light emitting units; and finally, stopping driving the light emitting units lighting when the current deviation overtaking a first threshold.

The advantage and spirit of the invention may be understood by the following recitations together with the appended drawings.

### BRIEF DESCRIPTION OF THE APPENDED DRAWINGS

FIG. 1A is a schematic diagram illustrating a driving apparatus and a plurality of light emitting units according to an embodiment of the invention.

FIG. 1B is a schematic diagram illustrating the internal structure of the deviation detecting unit in FIG. 1A.

FIG. 1C is a schematic diagram illustrating that the driving apparatus connects to the light emitting units according to another embodiment of the invention.

FIG. 1D is a schematic diagram illustrating that the driving apparatus connects to the light emitting units according to another embodiment of the invention.

FIG. 2A is a schematic diagram illustrating a backlight module according to an embodiment of the invention.

FIG. 2B is a schematic diagram illustrating a backlight module according to another embodiment of the invention.

FIG. 3A is a flow chart illustrating the driving method according to an embodiment of the invention.

FIG. 3B is a flow chart illustrating the driving method according to another embodiment of the invention.

FIG. 3C is a flow chart illustrating the driving method according to another embodiment of the invention.

### DETAILED DESCRIPTION OF THE INVENTION

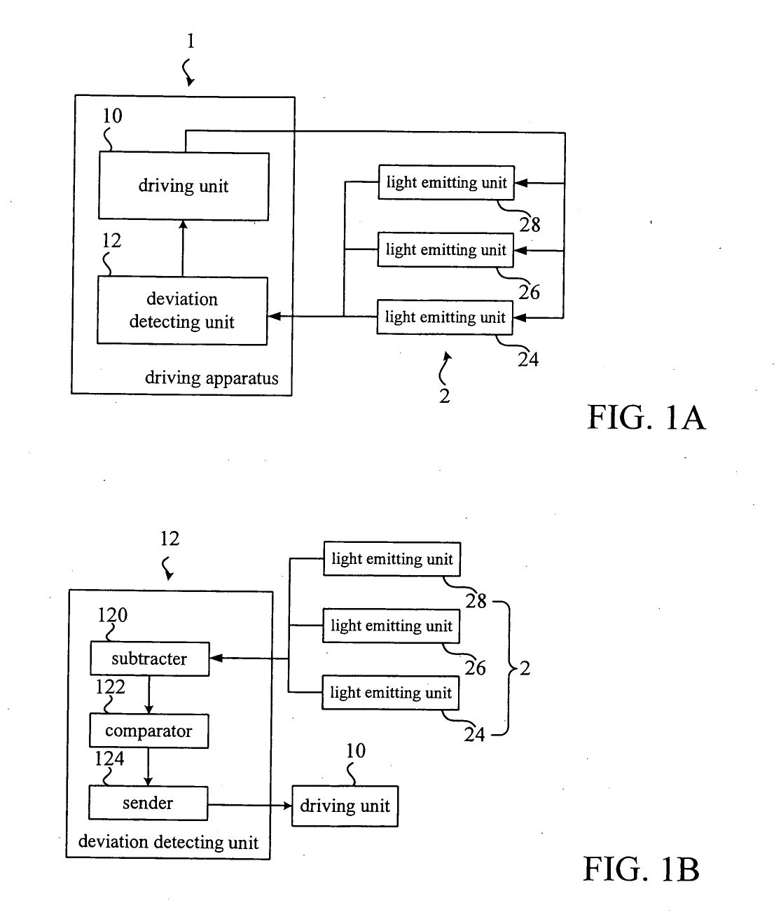

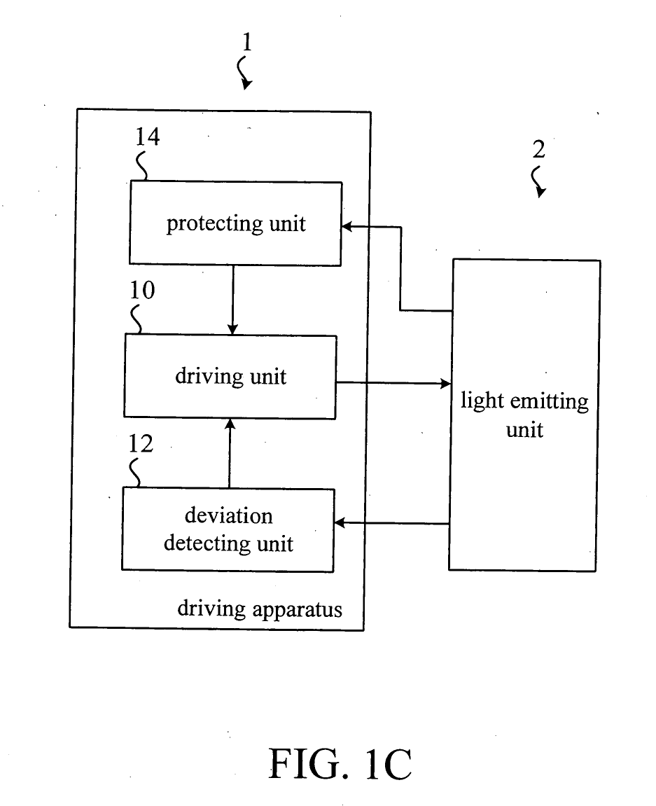

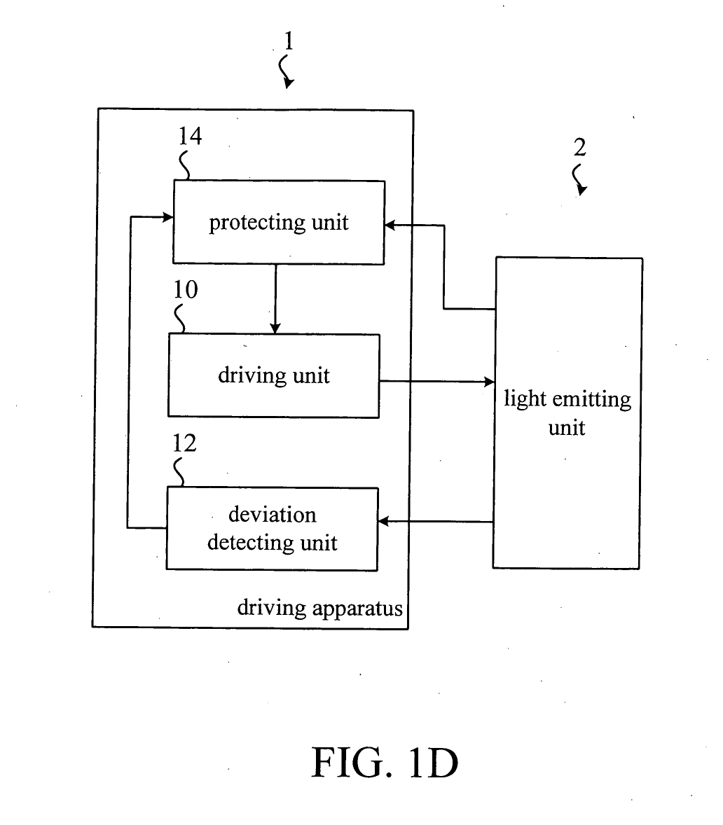

Please refer to FIG. 1A. FIG. 1A is a schematic diagram illustrating a driving apparatus 1 and a plurality of light emitting units 2 according to an embodiment of the invention. The driving apparatus 1 is used for driving the plurality of light emitting units 2 of a backlight module of a LCD to light. In practice, the LCD can be, but not limited to, a Thin-Film Transistor LCD (TFT-LCD). The light emitting units 2 can be, but not limited to, CCFLs.

In the embodiment, the backlight module includes three light emitting units 24, 26, and 28. As shown in FIG. 1A, the driving apparatus 1 includes a driving unit 10 and deviation detecting unit 12. The driving unit 10 is used for driving the light emitting units 2 lighting, and the driving unit 10 has a current balancing mechanism for stabilizing the voltage and the current of the light emitting units 24, 26, and 28 to make the brightness of the light emitted from the light emitting units 24, 26, and 28 substantially similar. The deviation detecting unit 12 can calculate a current deviation of each of the light emitting units 24, 26, and 28 respectively to reach secondary current balancing, and when the current deviation overtakes a first threshold, the deviation detecting unit 12 sends a first controlling signal to control the driving unit 10 to stop driving the light emitting units 2 lighting.

In practice, the first threshold can be set as a deviation range of 5%, and in the present driving circuit of LCD, the deviation range of 5% is about 1 mA. For example, when the deviation detecting unit 12 detects that the current deviations of the light emitting units 24, 26, and 28 are 3%, 2%, and 2% respectively, and no current deviation overtakes the first threshold, the light emitting units 2 will keep lighting. On the other hand, when the deviation detecting unit 12 detects that the current deviations of the light emitting units 24, 26, and 28 are 3%, 7%, and 2% respectively, and the current deviation of the light unit 26 overtakes the first threshold, the deviation detecting unit 12 will send a first controlling signal to control the driving unit 10 to stop driving the light emitting unit 26 or all the light emitting units 2 lighting. It should be noticed that the first threshold can be set as other values but not limited to 5% according to different situations.

Please refer to FIG. 1B. FIG. 1B is a schematic diagram illustrating the internal structure of the deviation detecting unit 12 in FIG. 1A. As shown in FIG. 1B, the detecting unit 12 includes a subtracter 120, a comparator 122, and a sender 124 according to another embodiment of the invention. The subtracter 120 is used for measuring a current difference between each of the light emitting units 2 respectively. In practice, the subtracter 120 can be formed of an operational amplifier and a subtracting circuit. The comparator 122 is used for calculating a current deviation of each of the light emitting units 2 respectively according to the current difference and the current of each of the light emitting units 2. The sender 124 is used for sending a first controlling signal to control the driving unit 10 to stop driving the light emitting units 2 lighting when the current deviation overtakes the first threshold.

Please refer to FIG. 1C. FIG. 1C is a schematic diagram illustrating that the driving apparatus 1 connects to the light emitting units 2 according to another embodiment of the invention. As shown in FIG. 1C, besides the elements of the above-mentioned embodiments, the driving apparatus 1 further includes protecting unit 14. When the voltage of any of the light emitting units 2 in open circuit overtakes a second threshold, the protecting unit 14 will send a second controlling signal to control the driving unit 10 to stop driving the light emitting units 2 lighting. In practice, the second threshold is higher than the normal voltage of the light emitting units in open circuit, i.e., 650V. Certainly, in practice, the second threshold can be set as other values but not limited to 650V.

Furthermore, please refer to FIG. 1D. FIG. 1D is a schematic diagram illustrating that the driving apparatus 1 connects to the light emitting units 2 according to another embodiment of the invention. As shown in FIG. 1D, in the embodiment, when the current deviation overtakes the first threshold, the deviation detecting unit 12 will send a first controlling signal to the protecting unit 14, so that the protecting unit 14 further sends the second controlling signal to control the driving unit 10 to stop driving the light emitting units 2 lighting.

In practice, the structure of the driving unit 10 can includes a current-fed parallel resonance circuit, a half-bridge series resonance inverter, a full-bridge phase shift inverter, a push-pull inverter, or other suitable driving device circuits.

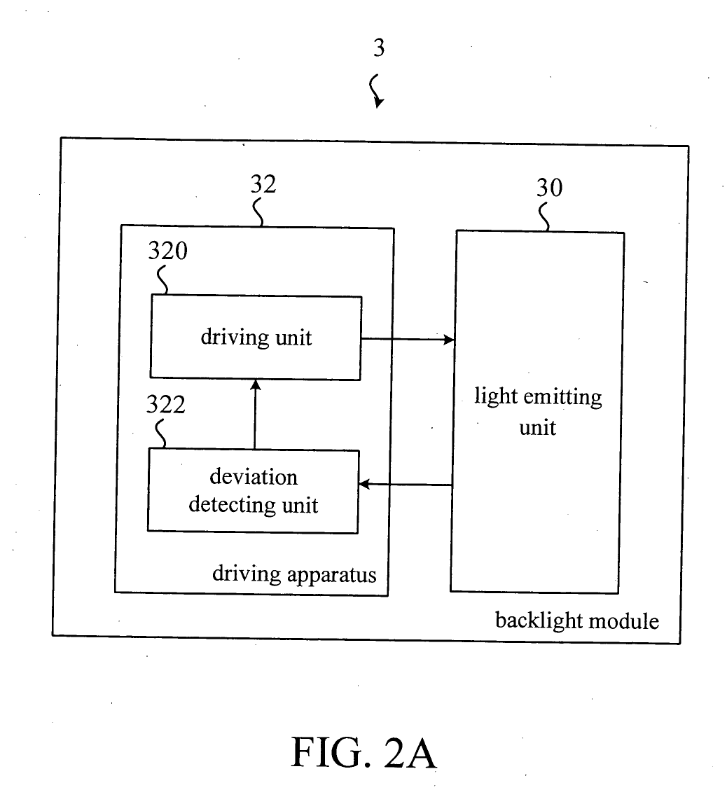

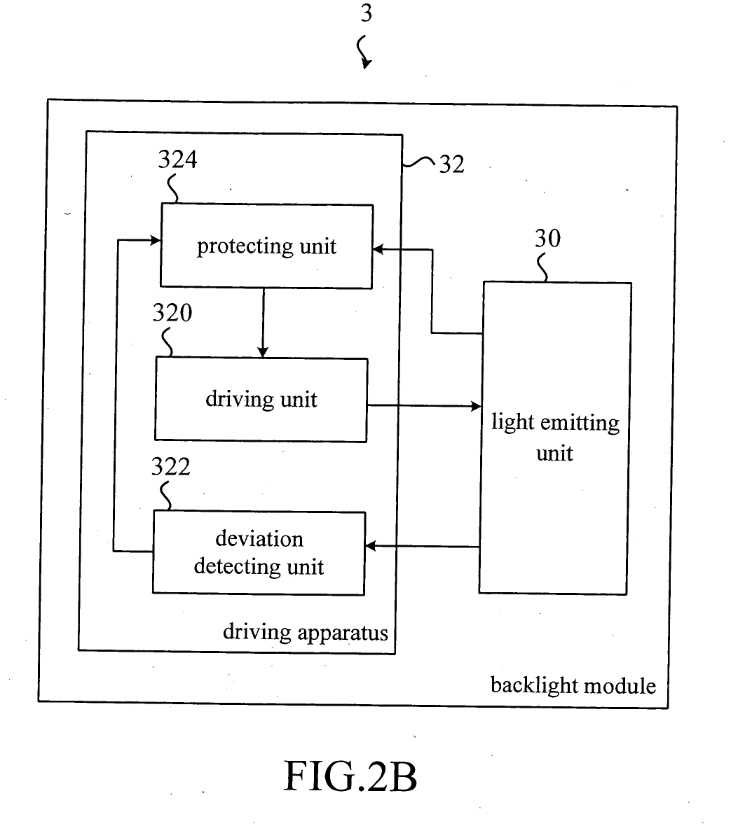

Please refer to FIG. 2A. FIG. 2A is a schematic diagram illustrating a backlight module 3 according to an embodiment of the invention. As shown in FIG. 2A, the backlight module 3 includes a light emitting unit 30 and a driving apparatus 32. It should be noticed that the light emitting unit 30 includes the plurality of light emitting units in FIG. 1A, and for the succinct figure, the light emitting unit 30 in FIG. 2A presents all the light emitting units. The driving apparatus 32 is used for driving the light emitting unit 30 lighting, and the driving apparatus 32 has a current balancing mechanism for stabilizing the voltage and current of each of the light emitting units 30 to make the brightness of the light emitted from each of the light emitting units 30 substantially similar. Besides, the driving apparatus 32 can calculate a current deviation of each of the light emitting units 30 and stop driving the light emitting unit 30 lighting when the current deviation overtakes a first threshold.

In the embodiment, the driving apparatus 32 can further include a driving unit 320 and a deviation detecting unit 322. The driving unit 320 is used for driving the light emitting unit 30 lighting. The deviation detecting unit 322 is used for calculating the current deviation of each of the light emitting units 30.

Please refer to FIG. 2B. FIG. 2B is a schematic diagram illustrating a backlight module 3 according to another embodiment of the invention. As shown in FIG. 2B, the driving apparatus 32 further includes a protecting unit 324. The protecting unit 324 will send a second controlling signal to control the driving unit 320 to stop driving the light emitting unit 30 lighting when the voltage of any of the light emitting units 30 in open circuit overtakes a second threshold. Besides, in the embodiment, the deviation detecting unit 322 will send a first controlling signal to the protecting unit 324 when the current deviation overtaking the first threshold, so that the protecting unit 324 further sends the second controlling signal to control the driving unit 320 to stop driving the light emitting unit 30 lighting.

In another embodiment, the protecting unit 324 can be independent from the driving apparatus 32, however, the operation of the protecting unit 324 is the same with that in the above-mentioned embodiment, so those are not described here.

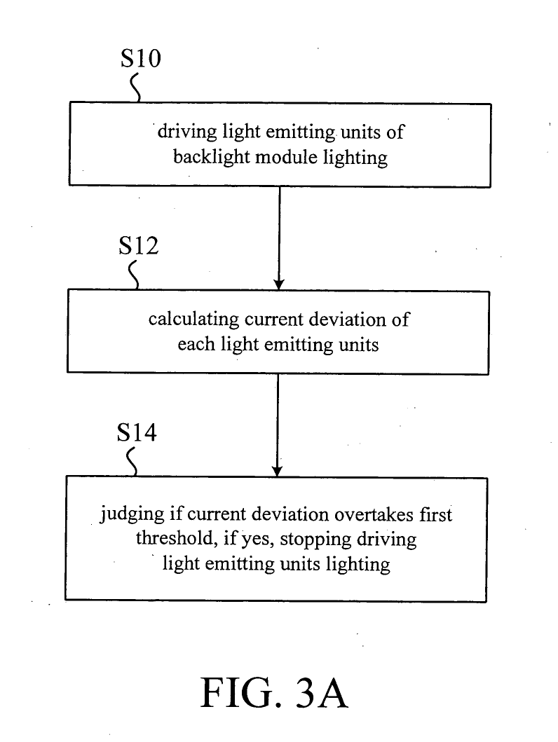

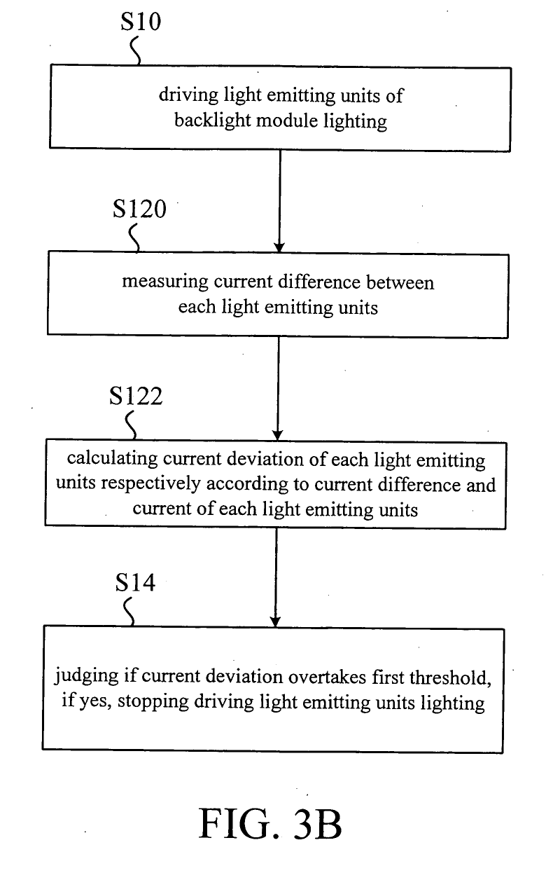

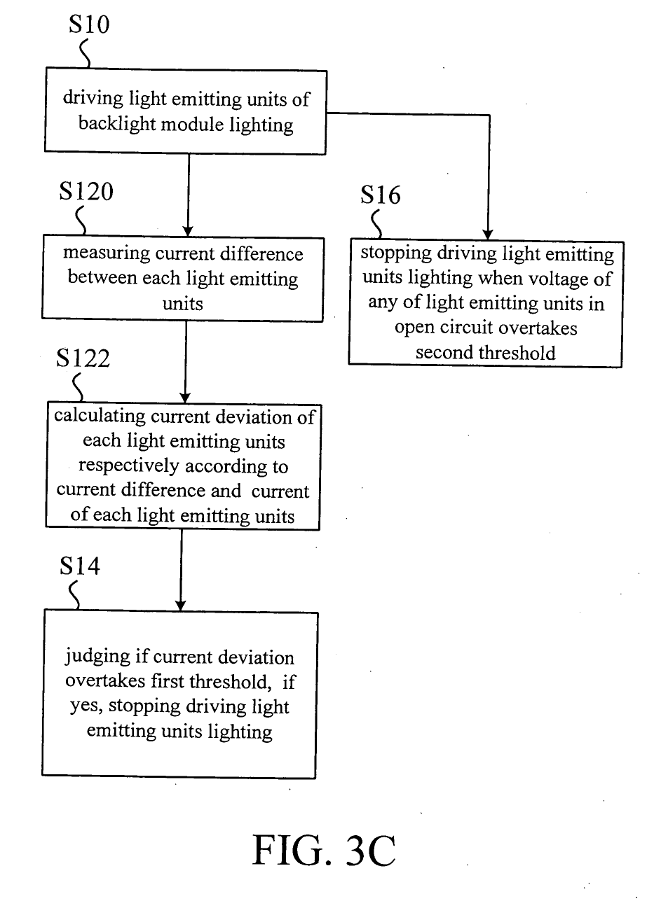

Please refer to FIG. 3A. FIG. 3A is a flow chart illustrating the driving method, for driving a backlight module of a LCD, according to an embodiment of the invention. In the embodiment, the driving method of the invention includes the following steps: firstly, in step S10, driving a plurality of light emitting units of the backlight module lighting; afterwards, in step S12, calculating a current deviation of each of the light emitting units; and finally, in step S14, judging if the current deviation overtakes a first threshold, and if yes, stopping driving the light emitting units lighting.

Please refer to FIG. 3B. FIG. 3B is a flow chart illustrating the driving method according to another embodiment of the invention. AS shown in FIG. 3B, the difference of the driving method of the embodiment from that of the last embodiment is that the step 12 further includes the following steps: in step S120, measuring a current difference between each of the light emitting units; and in step S122, calculating the current deviation of each of the light emitting units respectively according to the current difference and the current of each of the light emitting units. The other steps of the embodiment are the same with the corresponding steps of the last embodiment, and those are not described here.

Please refer to FIG. 3C. FIG. 3C is a flow chart illustrating the driving method according to another embodiment of the invention. As shown in FIG. 3C, the driving method of the invention further includes the following step: in step S16, stopping driving the light emitting units lighting when the voltage of any of the light emitting units in open circuit overtakes a second threshold. The other steps of the embodiment are the same with the corresponding steps of the above-mentioned embodiments, and those are not described here.

Compared to the prior art, the driving apparatus and method of the invention can measure and calculate the current deviation of each of the light emitting units, and the backlight module will stop lighting when the current deviation is overly large. Accordingly, it can be prevent from the condition that the brightness of the panel of LCD is not uniform to cause users uncomfortable and even to damage their vision.

While the invention has been described in some preferred embodiments, it is understood that the words which have been used are words of description rather than words of limitation and that changes within the purview of the appended claims may be made without departing from the scope and spirit of the invention in its broader aspect.

What is claimed is:

1. A driving apparatus, for driving a backlight module of a LCD, the driving apparatus comprising:
a driving unit for driving a plurality of light emitting units of the backlight module lighting; and
a deviation detecting unit for calculating a current deviation of each of the light emitting units;
wherein when the current deviation overtakes a first threshold, the deviation detecting unit controls the driving unit to stop driving the light emitting units lighting.

2. The driving apparatus of claim 1, wherein the deviation detecting unit further comprises:
a subtracter for measuring a current difference between each of the light emitting units respectively;
a comparator for calculating the current deviation of each of the light emitting units respectively according to the current difference and the current of each of the light emitting units; and
a sender for sending a first controlling signal to control the driving unit to stop driving the light emitting units lighting when the current deviation overtaking the first threshold.

3. The driving apparatus of claim 1, further comprising:
a protecting unit for sending a second controlling signal to control the driving unit to stop driving the light emitting units lighting when the voltage of any of the light emitting units in open circuit overtakes a second threshold.

4. The driving apparatus of claim 3, wherein deviation detecting unit further comprises:
a subtracter for measuring a current difference between each of the light emitting units respectively;
a comparator for calculating the current deviation of each of the light emitting units respectively according to the current difference and the current of each of the light emitting units; and
a sender for sending a first controlling signal to the protecting unit when the current deviation overtaking the first threshold, so that the protecting unit further sending the second controlling signal to control the driving unit to stop driving the light emitting units lighting.

5. The driving apparatus of claim 1, wherein the driving unit comprises at least one structure selected from a group consisting of a current-fed parallel resonance circuit, a half-bridge series resonance inverter, a full-bridge phase shift inverter, and a push-pull inverter.

6. The driving apparatus of claim 1, wherein the LCD is a thin-film transistor LCD (TFT-LCD).

7. The driving apparatus of claim 1, wherein the light emitting unit is a Cold Cathode Fluorescent Lamp (CCFL).

8. A backlight module, used in a LCD, the backlight module comprising:
a plurality of light emitting units; and
a driving apparatus for driving the light emitting units lighting and calculating a current deviation of each of the light emitting units;
wherein when the current deviation overtakes a first threshold, the driving apparatus stops driving the light emitting units lighting.

9. The backlight module of claim 8, wherein the driving apparatus further comprising:
a driving unit for driving the light emitting units lighting; and
a deviation detecting unit for calculating a current deviation of each of the light emitting units.

10. The backlight module of claim 9, wherein the driving apparatus further comprising:
a protecting unit for sending a second controlling signal to control the driving unit to stop driving the light emitting units lighting when the voltage of any of the light emitting units in open circuit overtakes a second threshold.

11. The backlight module of claim 9, wherein the driving unit comprises at least one structure selected from a group consisting of a current-fed parallel resonance circuit, a half-bridge series resonance inverter, a full-bridge phase shift inverter, and a push-pull inverter.

12. The backlight module of claim 8, wherein the LCD is a thin-film transistor LCD (TFT-LCD).

13. The backlight module of claim 8, wherein the light emitting unit is a Cold Cathode Fluorescent Lamp (CCFL).

14. A driving method for driving a backlight module of a LCD, the driving method comprising the following steps:
(a) driving a plurality of light emitting units of the backlight module lighting;
(b) calculating a current deviation of each of the light emitting units; and
(c) stopping driving the light emitting units lighting when the current deviation overtaking a first threshold.

15. The driving method of claim 14, wherein the step (b) further comprises the following steps:
(b1) measuring a current difference between each of the light emitting units; and
(b2) calculating the current deviation of each of the light emitting units respectively according to the current difference and the current of each of the light emitting units.

16. The driving method of claim 14, further comprising the following step:
(d) stopping driving the light emitting units lighting when the voltage of any of the light emitting units in open circuit overtaking a second threshold.

17. The driving method of claim 14, wherein the LCD is a thin-film transistor LCD (TFT-LCD).

18. The driving method of claim 14, wherein the light emitting unit is a Cold Cathode Fluorescent Lamp (CCFL).
